(19) United States
(12) Patent Application Publication
(10) Pub. No.: US 2020/0371641 A1
(43) Pub. Date: Nov. 26, 2020

(54) TOUCH CONTROL DISPLAY SCREEN AND METHOD OF MAKING THE SAME

(71) Applicants: Kunshan New Flat Panel Display Technology Center Co., Ltd., Kunshan (CN); KunShan Go-Visionox Opto-Electronics Co., Ltd., Kunshan (CN)

(72) Inventors: Feng ZHAI, Kunshan (CN); Huimin LIU, Kunshan (CN); Tao WANG, Kunshan (CN)

(73) Assignees: Kunshan New Flat Panel Display Technology Center Co., Ltd., Kunshan (CN); KunShan Go-Visionox Opto-Electronics Co., Ltd., Kunshan (CN)

(21) Appl. No.: 16/992,275

(22) Filed: Aug. 13, 2020

Related U.S. Application Data
(63) Continuation of application No. PCT/CN2019/103534, filed on Aug. 30, 2019.

(30) Foreign Application Priority Data
Oct. 19, 2018 (CN) 201811222080.X

(51) Int. Cl. G06F 3/044; G06F 3/041

(52) U.S. Cl. CPC G06F 3/0443; G06F 3/0445; G06F 3/04164; G06F 2203/04104; G06F 2203/04111; G06F 2203/04103; G06F 2203/04102

(57) ABSTRACT

A touch control display screen includes: a display device layer including a display device elastic substrate and a display device disposed in the display device elastic substrate; and a touch control layer disposed on a surface of the display device elastic substrate. As the display device is disposed into the elastic substrate, it is possible for the touch control display screen to achieve the function of stretchability by the stress produced in the elastic substrates' stretching.

### CROSS-REFERENCE TO RELATED APPLICATIONS

This application is a continuation of International Application No. PCT/CN2019/103534 filed on Aug. 30, 2019, which claims priority of Chinese patent application No. 201811222080.X filed on Oct. 19, 2018. The entire content of the both applications is incorporated herein by reference in their entireties.

### TECHNICAL FIELD

The present disclosure relates to the field of a display screen, and particularly to a touch control display screen and a method of making the same.

### BACKGROUND

Flexible displays may be classified into curved displays, foldable displays, and stretchable displays. The curved displays and the foldable displays have been already in commercial use. Recently, an organic light emitting display with stretchable structure is expectable to form an organic light emitting display with stretchable substrate. The organic light emitting display is able to be extended/stretchable, contractible, or bended when being pulled. The substrate can be stretched, but metal electrodes, electronic devices, etc. cannot be stretched. The pressure which is caused by stretching, shrinking and bending of the substrate when being stretched may cause cracks of the metal electrodes and the electronic devices. Touch and Display Driver Integration (TDDI), which integrates a touch sensor and a display unit and assists the integration of a touch and a display driver, is a developing trend of a new generation of the touch display technology. An ultimate form of a stretchable display device is a combination of a stretchable touch sensor and a stretchable display device. Therefore, how to make the touchable stretching display device becomes a key issue.

### SUMMARY

In view of this, embodiments of the present disclosure provide a touch control display screen and a method of making the same, which resolves a problem that a stress generated during a stretched process of a flexible touch control display screen causes a crack of a metal electrode and an electronic device.

According to one aspect of exemplary embodiments of the present disclosure, a touch control display is provided. The touch control display screen includes a display device layer including a display device elastic substrate and a display device disposed in the display device elastic substrate; and a touch control layer disposed on a surface of the display device elastic substrate.

In an embodiment, an elastic protective layer is disposed on an upper surface of the touch layer and configured to protect the touch control layer.

In an embodiment, the touch control layer includes a flexible conductive layer and a lead electrically connected with the flexible conductive layer.

In an embodiment, the lead includes a stretchable silver paste and the flexible conductive layer includes a combination of any one or more of the following conductive materials: silver nanoparticles, Graphene, and carbon nano-tube.

In an embodiment, an elastic protective layer is disposed on a surface of the touch control layer away from the display device layer.

In an embodiment, the touch control display screen includes a pair of said touch control layers and a touch control elastic substrate disposed between the pair of said touch control layers.

In an embodiment, the touch control display screen includes said touch control layer with a plurality of conductive regions and a plurality of leads electrically connected to the conductive regions.

In an embodiment, the touch control layer includes at least one metal bridge each electrically connected to two conductive regions.

In an embodiment, the flexible conductive layer includes a plurality of first conductive regions and a plurality of second conductive regions which are arranged at intervals corresponding to the first conductive regions. At least one metal bridge is electrically connected to the first conductive regions or the second conductive regions.

In an embodiment, each metal bridge contains any one of the following metal materials: indium tin oxide, Mo—Al alloy, Ti—Al alloy and Cu.

In an embodiment, the display device elastic substrate contains any one of the following elastic materials: polydimethylsiloxane, elastic polyimide, polyurethanes elastomer and acrylic elastomer.

In an embodiment, the touch control elastic substrate includes any one of following elastic materials: polydimethylsiloxane, elastic polyimide, polyurethanes elastomer and acrylic elastomer.

According to another aspect of exemplary embodiments of the present disclosure, a method of making a touch control display screen is provided. The method includes: making or providing a rigid substrate; coating an organic layer on the rigid substrate; making a display device on an upper surface of the organic layer; coating a first display device elastic substrate on an upper surface of the display device; making a touch control layer on an upper surface of the first display device elastic substrate; peeling the rigid substrate; and casting a second display device elastic substrate on a lower surface of the organic layer.

In an embodiment, after making a touch control layer on the upper surface of the first display device elastic substrate, the method further includes: coating an elastic protective layer on an upper surface of the touch control layer.

In an embodiment, the touch control display screen includes a pair of said touch control layers and a touch control elastic substrate disposed between the pair of said touch control layers; and the method of making a touch control layer on the upper surface of the first display device elastic substrate includes: making a first touch control layer on the upper surface of the first display device elastic substrate; coating the touch control elastic substrate on the upper surface of the first touch control layer; and making a second touch control layer on the upper surface of the touch control elastic substrate.

In an embodiment, the touch control display screen includes said touch control layer and a touch control elastic substrate, the touch control layer includes a metal bridge, the method of making a touch control layer on the upper surface of the first display device elastic substrate includes: making a plurality of first conductive regions and a plurality of second conductive regions on the upper surface of the first display device elastic substrate; making a lead to connect the first conductive regions, and making the metal bridge to connect the second conductive regions; and disposing an insulating layer between the first conductive regions and the second conductive regions.

In an embodiment, the method of making a display device on the upper surface of the organic layer includes: making a rigid island driving circuit; making a wire connected to the rigid island driving circuit; and binding a display unit to the rigid island driving circuit.

Embodiments of the present disclosure provide a touch control display screen having several elastic substrates described above. As the display device is disposed into the elastic substrate and elastic substrates are disposed in both of the upper and lower surface of the touch control layer, it is possible for the touch control display screen to achieve the function of stretchability by the stress produced in the elastic substrates' stretching.

### BRIEF DESCRIPTION OF DRAWINGS

FIG. 1 is a sectional diagram of a touch control display screen according to an embodiment of the present disclosure.

FIG. 2 is a top view of a touch control display screen according to an embodiment of the present disclosure.

FIG. 3 is a sectional diagram of a touch control display screen according to another embodiment of the present disclosure.

FIG. 4 is a sectional diagram of a touch control display screen according to another embodiment of the present disclosure.

FIG. 5 is a flow schematic diagram of a method of making a touch control display screen according to an embodiment of the present disclosure.

FIG. 5a-5g are structural schematic diagrams of a touch control display screen in the process of making the touch control display screen.

FIG. 6 is a flow schematic diagram of a method of making a touch control display screen according to another embodiment of the present disclosure.

FIG. 7 is a flow schematic diagram of a method of making a touch control display screen according to another embodiment of the present disclosure.

FIG. 8 is a flow schematic diagram of a method of making a touch control display screen according to another embodiment of the present disclosure.

### DETAILED DESCRIPTION OF THE EMBODIMENTS

The technical scheme in the embodiments of the disclosure will be described clearly and completely below in combination with drawings. Obviously, the described embodiments are only a part of the embodiments of the present disclosure, not all of the embodiments. Based on the embodiments of the present disclosure, all other embodiments obtained by those skilled in the art without creative efforts shall fall within the protection scope of the present disclosure.

For convenience, defining a vertical direction as a placement direction of a display screen and a glow direction of the display screen. Therefore, “an upper surface” is defined as a surface on the top of each film layer in the vertical direction or a surface on the top of the display screen in the glow direction.

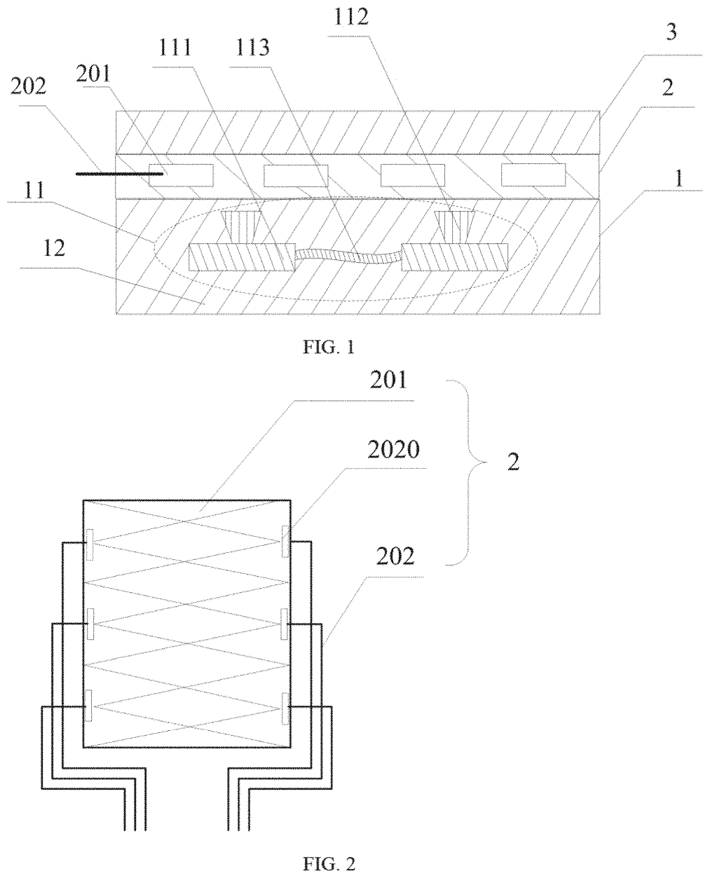

As shown in FIG. 1, the touch control display screen includes a display device layer 1 provided for displaying and a touch control layer 2 disposed on an upper surface of the display device layer 1 and provided for a touch control function. The display device layer 1 includes a display device 11 and a display device elastic substrate 12. The display device 11 is disposed into the display device elastic substrate 12. The display device 11 includes a rigid island driving circuit 111, a display unit 112 disposed on the rigid island driving circuit 111, and a wire 113 connected to the rigid island driving circuit 111. The wire 113 has a stretchable to stretch the display device 11. The rigid island driving circuit 111 is a driving circuit placed in a rigid island. The material of the electronic components used for a driving function in a flexible electronic structure is usually too brittle to have a brittle fracture in a preparation and in a usage. Therefore, for protecting the electronic technology components from being damaged during bending, the electronic technology components are placed in a rigid micro-cell island (that is, the rigid island), and distributed on a circuit board.

As the display device 11 is disposed into the display device elastic substrate 12 and elastic substrates are disposed in both of the upper and lower surface of the touch control layer 2, cracks and damages of the display device 11 and the touch control layer 2 will not occur during the stretching process and it is possible for the touch control display screen to achieve the function of stretchability by the stress produced in the elastic substrates' stretching.

In an embodiment, an elastic protective layer 3 is disposed on the upper surface of the touch control layer 2 to protect the touch control layer 2 and achieve stretching function of the display screen to improve the security of the touch control layer 2. In this embodiment, the elastic protective layer 3 can be viewed as a protective layer separately disposed on the upper surface of the touch control layer 2 or a part of the touch control layer 2. The position of the elastic protective layer 3 is not defined.

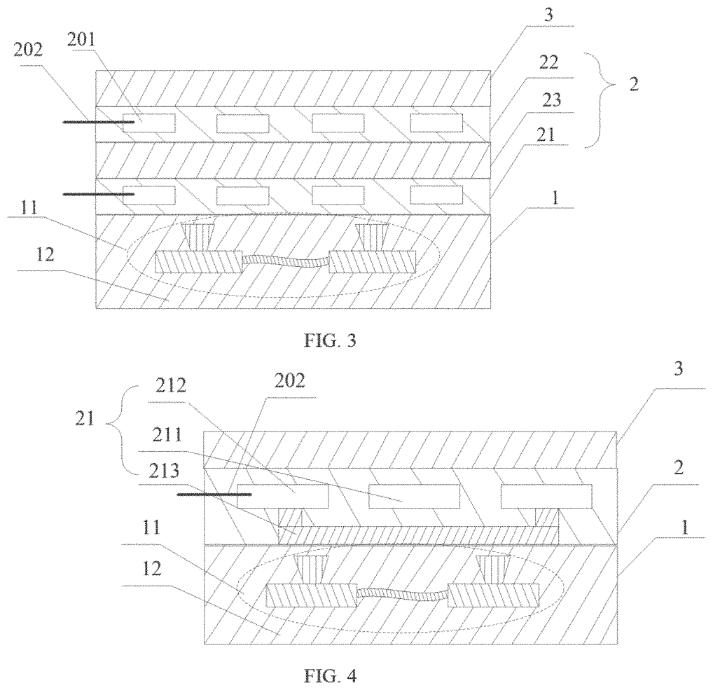

As shown in FIG. 2, the touch control layer 2 includes a flexible conductive layer 201 and a lead 202 electrically connected with the flexible conductive layer 201. The flexible conductive layer 201 is formed into one or any combination of the shapes of rhombus, circular and oval by patterning and formed into a plurality of conductive regions in the touch control layer 2. The lead 202 includes a pin 2020 disposed on an edge of the flexible conductive layer 201. One free end of each lead 202 is electrically connected to one conductive region of the flexible conductive layer 201 through the pin 2020, and the other end is electrically connected to an external circuit. The leads 202 are centralized in one side of the flexible conductive layer 201. The leads 202 of the touch control layer 2 include a plurality of pins 2020. While ensuring a function of the lead 202 in the touch control layer 2, the structure of the lead 202 and the process for making the lead 202 is simplified to ensure the lead 202 effective in the touch control layer 2 and with no complicated pattern. When a finger of a user or a stylus touches the conductive region of the flexible conductive layer 201, a capacitance value of the surface of the touch control layer 2 is changed and the touch control layer 2 converts the change of the capacitance value into a current signal and transmits the current signal to the lead 202. That is, the flexible conductive layer 201 converts the change of the surface capacity value of the touch control layer 2 into the current signal, and the current signal is transmitted into the lead 202. The lead 202 transmits the current signal to an external circuit to realize a single-touch or virtual two-touch.

In addition, the lead 202 includes a stretchable silver paste used for achieving the stretchability of the touch control layer 2. The flexible conductive layer 201 may comprise a combination of any one or more of the following conductive materials: silver nanoparticles, Graphene and carbon nano-tube. The materials of the lead 202 and the flexible conductive layer 201 listed in the embodiments of the present disclosure are exemplary. In the embodiments of the present disclosure, different materials may be selected as the conductive materials of the lead 202 and the flexible conductive layer 201 according to different disclosure. As long as the selected conductive material can achieve a conductive performance of the touch control layer 2, the conductive materials of the lead 202 and the flexible conductive layer 201 is not confined.

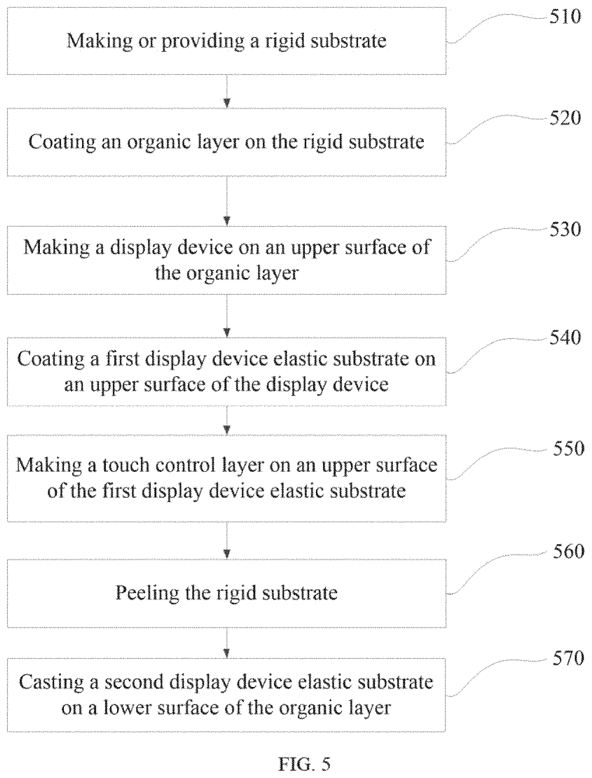

As shown in FIG. 3, the touch control display screen includes a first touch control layer 21 and a second touch control layer 22 and a touch control elastic substrate 23 disposed between the first touch control layer 21 and the second touch control layer 22. The first touch control layer 21 is disposed between the touch control elastic substrate 23 and the display device elastic substrate 12, and the second touch control layer 22 is disposed between the touch control elastic substrate 23 and the elastic protective layer 3. The first touch control layer 21 and the second touch control layer 22 may be viewed as a driving channel layer and a sensing channel layer respectively.

In the touch control display screen with two touch control layers, when two fingers of the user touch the touch control layer at the same time, each finger will simultaneously changes the surface capacity value of the first touch control layer 21 and the second touch control layer 22. A channel direction of the first touch layer 21 is different from that of the channel direction of the second touch layer 22. The two channel directions are perpendicular to each other. Then the first touch control layer 21 and the second touch control layer 22 respectively convert capacitance changes into current signals, and transmit each current signal to different leads 202. The two current signals are transmitted to the external circuits respectively by the different leads 202. According to the surface capacity changes of the first touch control layer 21 and the second touch control layer 22, positions of the two fingers in the channel directions of the first touch control layer 21 and the second touch control layer 22 are determined respectively, and positions of the two fingers on the touch layer 2 are determined according to the positions in the two different directions, so as to realize the function of double-layer multi-touch. Furthermore, a touch control elastic substrate 23 formed by an insulating material is disposed between the two touch control layers 21 and 22. The touch control elastic substrate 23 can realize the insulation between the two touch control layers 21 and 22, and avoid the cracks and damages of the two touch control layers 21 and 22 during the stretching process, so as to achieve the stretchability of the touch control display screen.

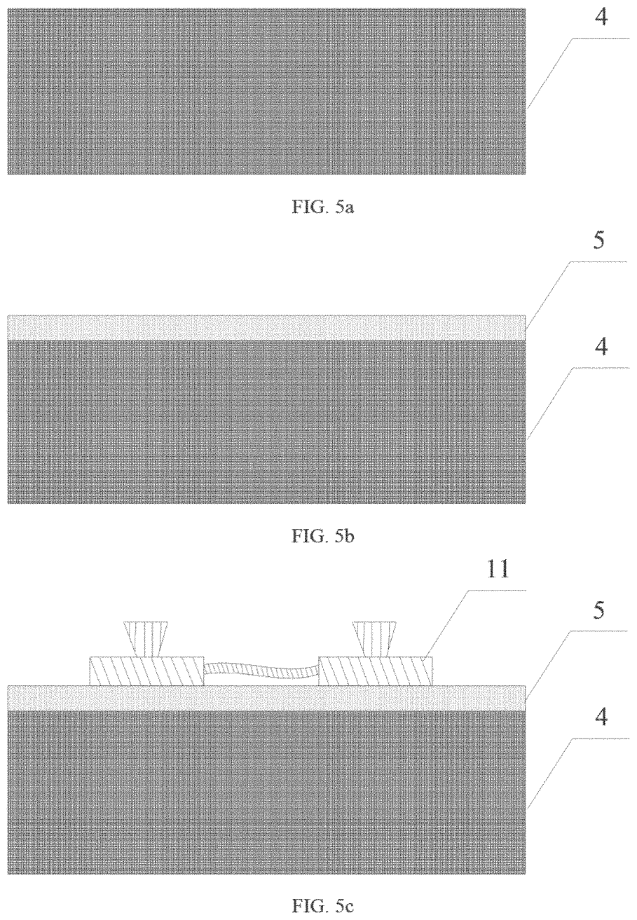

As shown in FIG. 4, the touch control layer 2 may include only the first touch layer 21 and at least one metal bridge 213, and the first touch control layer 21 may include a plurality of first conductive regions 211 and a plurality of second conductive regions 212. The first conductive regions 211 and the second conductive regions 212 are arranged at intervals. The first conductive regions 211 are electrically connected with each other and electrically connected to an external circuit to form a loop. The second conductive regions 212 are electrically connected with each other and electrically connected to an external circuit to form a loop. An insulating structure is disposed between the first conductive region 211 and the second conductive region 212. Due to an insulation being demanded between the first conductive region 211 and the second conductive region 212 which are disposed on the same touch control layer, if both the first conductive region 211 and the second conductive region 212 are electrically connected to an external circuit through the leads 202, the leads 202 connected to the first conductive region 211 and the second conductive region 212 may cause a cross shorting. Therefore, each metal bridge 213 is electrically connected with two second conductive regions 212 to achieve that the second conductive regions 212 in the first touch control layer 21 are electrically connected with each other and do not cause the cross shorting with the lead 202 electrically connected to the first conductive region 211. The metal bridges 213 are disposed in the first touch control layer 21 to electrically connect the second conductive regions 212 to form a loop, thereby the single layer multi-touch is achieved.

In an embodiment, the metal bridge 213 may be disposed to be electrically connected with the first conductive region 211 and a number of the metal bridge 213 corresponds to a number of the first conductive regions 211. Or the metal bridge 213 may also be disposed to be electrically connected with the second conductive region 212 and the number of the metal bridge 213 corresponds to the number of the second conductive regions 212. The electrical connections objects and the number of the metal bridge 213 are not defined.

In an embodiment, preferably, the metal bridge 213 contains any one of the following metal materials: indium tin oxide, Mo—Al alloy (such as molybdenum, aluminum and molybdenum, etc.), Ti—Al alloy (such as titanium, aluminum and titanium, etc.) and Cu. The metal bridge 213 can achieve a good electrical connection effect. In this embodiment, different materials may be selected as the metal material of the metal bridge 213 according to different disclosure scenarios, as long as the selected metal materials can realize the electrical connection of two conductive regions with the metal bridge 213.

In an embodiment, preferably, the display device elastic substrate 12 may contain any one of the following elastic materials: polydimethylsiloxane, elastic polyimide, polyurethanes elastomer and acrylic elastomer. The display device elastic substrate 12 can achieve a good stretching effect. In this embodiment, different elastic materials may be selected as the material of the display device elastic substrate 12 according to different disclosure scenarios, as long as the selected elastic material can achieve the stretchability of the display device elastic substrate 12.

In an embodiment, preferably, the touch control elastic substrate 23 may contain any one of the following elastic materials: polydimethylsiloxane, elastic polyimide, polyurethanes elastomer and acrylic elastomer. In this embodiment, different elastic materials may be selected as the material of the touch control elastic substrate 23 according to different disclosure scenarios, as long as the selected elastic material can achieve the stretchability of the touch control elastic substrate 23. The material of the touch control elastic substrate 23 is not defined.

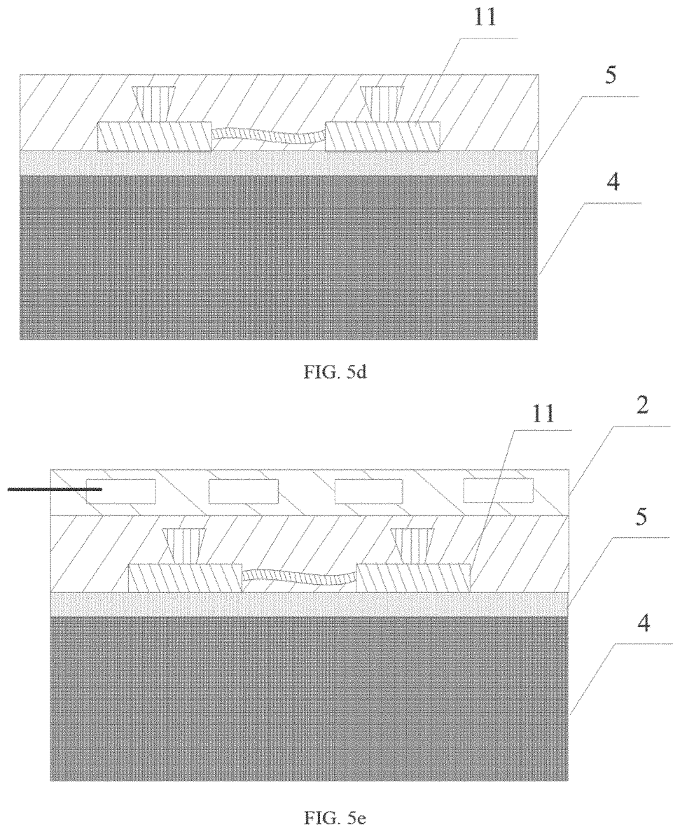

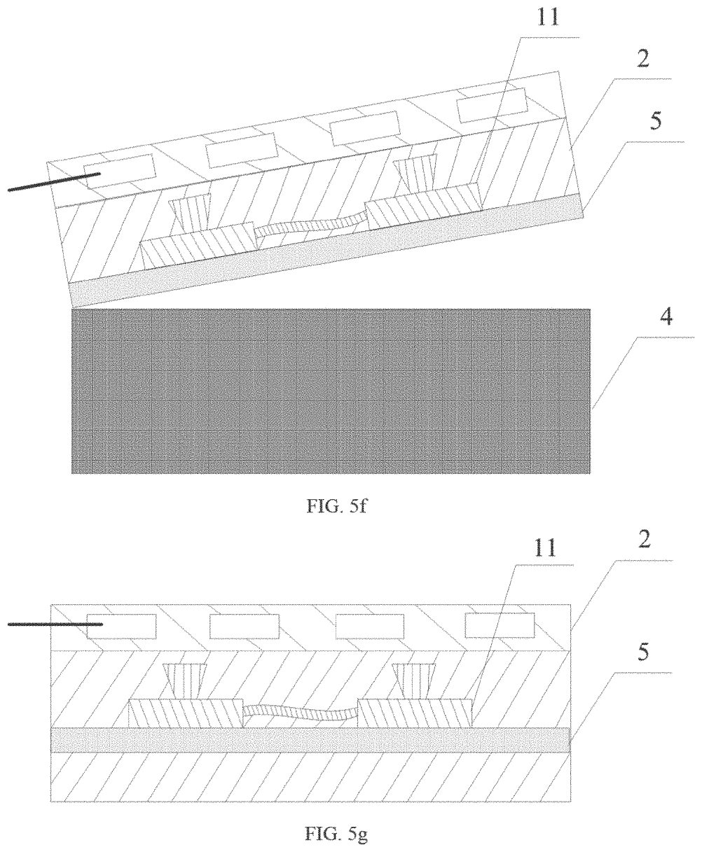

As shown in FIG. 5, the method of making the touch control display screen specifically includes the following steps.

Step 510: making or providing a rigid substrate.

Referring to FIG. 5, the rigid substrate refers to a substrate with a high rigidity and placed on the bottom of the display screen to support the superposition or coating of various functional film layers during the making of the display screen. Due to the high rigidity, the rigid substrate provides a resistant pressure and a small deformation substrate in the process of making the display screen, so as to ensure a small deformation of the display screen in the process of making the display screen and the preparation accuracy is high. In this embodiment, the rigid substrate 4 may be a glass substrate, but it should be understood that other rigid materials may also be used as the rigid materials of the rigid substrate 4 during the display screen preparing process.

Step 520: coating an organic layer on the rigid substrate.

In an embodiment, the organic layer 5 may be a PI layer, and the organic layer 5 is patterned after being coated.

Step 530: making a display device on an upper surface of the organic layer.

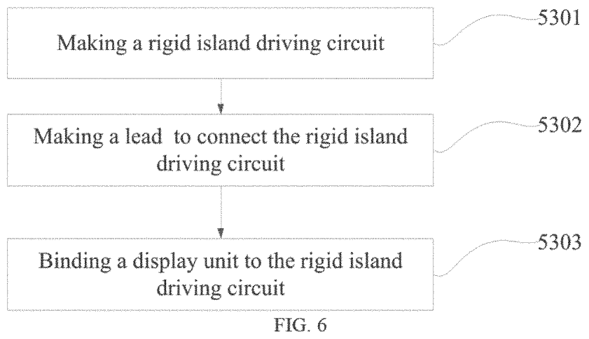

The display device 11 is provided to realize a display function. The display device 11 is made on the upper surface of the organic layer 5. The organic layer 5 can protect the display device 11 and achieve the stretchability of the touch control display screen. As shown in FIG. 6, the method of making the display device 11 may specifically include the following steps.

Step 5301: making a rigid island driving circuit.

Step 5302: making a wire to connect the rigid island driving circuit.

Step 5303: binding a display unit to the rigid island driving circuit.

Step 540: coating a first display device elastic substrate on an upper surface of the display device.

The first display device elastic substrate coated on the upper surface of the display device 11 that has elastic, and the first display device elastic substrate can release the stress generated during the stretching process.

Step 550: making a touch control layer on an upper surface of the first display device elastic substrate.

The touch control layer 2 is provided to realize the touch control function. The touch control layer 2 is patterned after being made. The touch control layer 2 is made on the upper surface of the first display device elastic substrate, and the first display device elastic substrate can release the stress generated during the stretching process.

Step 560: peeling the rigid substrate.

After the display device 11, the touch layer 2 and the first display screen elastic substrate of the display device are made, the rigid substrate 4 is flexibly peeled off from the display screen. A flexible peeling refers to making a display device 11 by disposing the flexible display screen on the rigid substrate 4 and then separating the flexible display screen from the rigid substrate 4 after the display device 11 is made. The flexible peeling includes, but is not limited to, a laser peeling technology.

Step 570: casting a second display device elastic substrate on a lower surface of the organic layer.

After the rigid substrate 4 is peeled off from the flexible display screen, the second display device elastic substrate is cast on the lower surface of the organic layer 5, so as to further release the stress generated during the stretching process.

After Step 550, the method may further include: coating an elastic protective layer 3 on the upper surface of the touch control layer 2. As the elastic protective layer 3 is coated onto the upper surface of the touch control layer 2, the elastic protective layer 3 can protect the touch control layer 2 from being damaged by the touch control force and also completely release the stress generated during the stretching process.

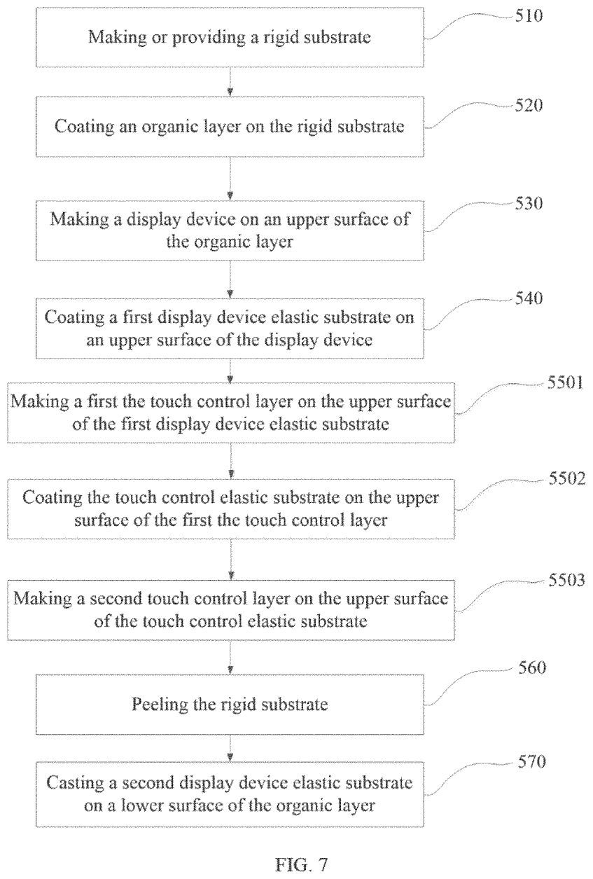

As shown in FIG. 7, the touch control display screen may include two touch layers 21 and 22 and a touch control elastic substrate 23. Step 550 in the above embodiment may further include the following sub-steps.

Step 5501: making a first the touch control layer on the upper surface of the first display device elastic substrate.

The first touch control layer 21 is made on the first display device elastic substrate, and then is patterned after being made. The first display device elastic substrate can release the stress generated during the stretching process.

Step 5502: coating the touch control elastic substrate on the upper surface of the first the touch control layer.

As the first display device elastic substrate and the touch control elastic substrate 23 are provided, the stress generated during the stretching process can be released, and it can be ensured that the first touch control layer 21 do not be damaged during the stretching process.

Step 5503: making a second touch control layer on the upper surface of the touch control elastic substrate.

The second touch control layer 22 is made on the touch control elastic substrate 23, and then is patterned after being made. As the touch control elastic substrate 23 with an insulation characteristic is provided, the stress generated in the stretching process can be released, and the insulation between the first touch control layer 21 and the second touch control layer 22 can be realized.

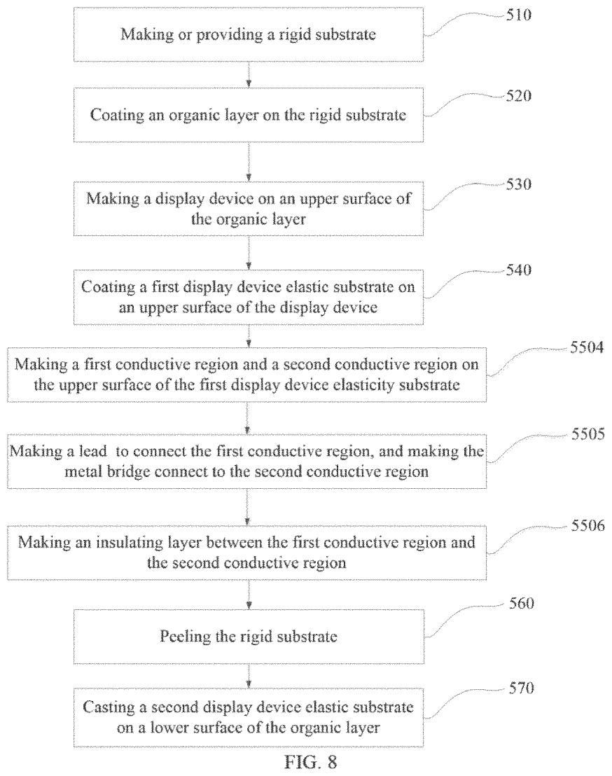

As shown in FIG. 8, the touch control display screen may include only the first touch control layer 21 and the touch control elastic substrate 23, and the first touch control layer 21 includes a metal bridge 213. Step 550 may further include the following sub-steps.

Step 5504: making a first conductive region and a second conductive region on the upper surface of the first display device elastic substrate.

A plurality of the first conductive regions 211 and a plurality of the second conductive regions 212 arranged at intervals are made on the upper surface of the first display device elastic substrate. The first conductive regions 211 and the second conductive regions 212 collect touch control signals in two directions respectively, and then transmit the two touch control signals to external circuits to achieve the multi-touch.

Step 5505: making a lead to connect the first conductive region, and making the metal bridge to connect the second conductive region.

As the lead 202 connected to the first conductive region 211 and the metal bridge 213 connected to the second conductive region 212 are made, the cross shorting between the first conductive region 211 and the second conductive region 212 is avoided.

Step 5506: disposing an insulating layer between the first conductive region and the second conductive region.

As the insulating layer between the first conductive region and the second conductive region is provided, the cross-shorting between the first conductive region and the second conductive region is avoided and the single layer multi-touch is achieved.

The above embodiments are only the preferred embodiments of the present disclosure, and are not intended to limit the protection scope of the present disclosure. Any modifications, equivalent replacements, improvements, etc. made within the spirit and principles of the present disclosure should be included within the protection scope of the present disclosure.

What is claimed is:

1. A touch control display screen, comprising:
a display device layer comprising a display device elastic substrate and a display device disposed in the display device elastic substrate; and
a touch control layer disposed on a surface of the display device elastic substrate.

2. The touch control display screen according to claim 1, wherein an elastic protective layer is disposed on an upper surface of the touch layer and configured to protect the touch control layer.

3. The touch control display screen according to claim 1, wherein the touch control layer comprises a flexible conductive layer and a lead electrically connected with the flexible conductive layer.

4. The touch control display screen according to claim 3, wherein the lead comprises a stretchable silver paste and the flexible conductive layer comprises a combination of any one or more of the following conductive materials: silver nanoparticles, Graphene, and carbon nano-tube.

5. The touch control display screen according to claim 1, wherein an elastic protective layer is disposed on a surface of the touch control layer away from the display device layer.

6. The touch control display screen according to claim 1, wherein the touch control display screen comprises a pair of said touch control layers and a touch control elastic substrate disposed between the pair of said touch control layers.

7. The touch control display screen according to claim 1, wherein the touch control display screen comprises said touch control layer with a plurality of conductive regions and a plurality of leads electrically connected to the conductive regions.

8. The touch control display screen according to claim 7, wherein the touch control layer further comprises at least one metal bridge each electrically connected to two conductive regions.

9. The touch control display screen according to claim 8, wherein the flexible conductive layer comprises a plurality of first conductive regions and a plurality of second conductive regions which are arranged at intervals corresponding to the first conductive regions, and at least one metal bridge is electrically connected to the first conductive regions or the second conductive regions.

10. The touch control display screen according to claim 8, wherein each metal bridge comprises at least one of the following metal materials: indium tin oxide, Mo—Al alloy, Ti—Al alloy and Cu.

11. The touch control display screen according to claim 6, wherein the display device elastic substrate and the touch control elastic substrate both comprise at least one of the following elastic materials: polydimethylsiloxane, elastic polyimide, polyurethanes elastomer and acrylic elastomer.

12. A method of making a touch control display screen, comprising:
making or providing a rigid substrate;
coating an organic layer on the rigid substrate;
making a display device on an upper surface of the organic layer;
coating a first display device elastic substrate on an upper surface of the display device;
making a touch control layer on an upper surface of the first display device elastic substrate;
peeling the rigid substrate; and
casting a second display device elastic substrate on a lower surface of the organic layer.

13. The method according to claim 12, wherein after making a touch control layer on the upper surface of the first display device elastic substrate, the method further comprises:
coating an elastic protective layer on an upper surface of the touch control layer.

14. The method according to claim 12, wherein the touch control display screen comprises a pair of said touch control layers and a touch control elastic substrate disposed between the pair of said touch control layers; and the method of making a touch control layer on the upper surface of the first display device elastic substrate comprises:
making a first touch control layer on the upper surface of the first display device elastic substrate;
coating the touch control elastic substrate on the upper surface of the first the touch control layer; and
making a second touch control layer on the upper surface of the touch control elastic substrate.

15. The method according to claim 12, wherein the touch control display screen comprises said touch control layer and a touch control elastic substrate, the touch control layer comprises a metal bridge, the method of making a touch control layer on the upper surface of the first display device elastic substrate comprises:
making a plurality of first conductive regions and a plurality of second conductive regions on the upper surface of the first display device elastic substrate;
making a lead to connect the first conductive regions, and making the metal bridge to connect the second conductive regions; and
disposing an insulating layer between the first conductive regions and the second conductive regions.

16. The method according to claim 12, wherein the method of making a display device on the upper surface of the organic layer comprises:
making a rigid island driving circuit;
making a wire connected to the rigid island driving circuit; and
binding a display unit to the rigid island driving circuit.
